(19) United States
(12) Patent Application Publication
(10) Pub. No.: US 2017/0312786 A1
(43) Pub. Date: Nov. 2, 2017

(54) SCREEN GRATING

(71) Applicant: Binder + Co AG, Gleisdorf (AT)

(72) Inventor: Christian Url, Edelsbach (AT)

(21) Appl. No.: 15/499,538

(22) Filed: Apr. 27, 2017

(30) Foreign Application Priority Data
May 2, 2016 (AT) 50069/2016

(51) Int. Cl. B07B 1/46

(52) U.S. Cl. CPC B07B 1/4681

(57) ABSTRACT

The invention relates to a screen grating for size-dependent separation of bulk materials, comprising a plurality of grating bars (2) spaced apart one alongside another, which form a screen surface (1) and which have a smaller dimension in the width direction (y), which runs parallel to the screen surface (1) and perpendicular to the longitudinal direction (x) of the screen grating bars (2), than in the height direction (z), wherein the height direction (z) is perpendicular to the screen surface (1) and perpendicular to the longitudinal direction (x) of the grating bars (2). To prevent clogging, it is provided that the cross section of the grating bars (2) perpendicular to the longitudinal axis (x) tapers down with increasing distance from the screen surface (1) in a first portion (9) of the grating bars (2) that adjoins the screen surface (1) such that, in this height region, the width of a gap between two grating bars (2) expands in the height direction, and that the grating bars (2) are arranged parallel to one another, more particularly in the conveyance direction of the bulk material.

### FIELD OF THE INVENTION

The invention relates to a screen grating for size-dependent separation of bulk materials, comprising a plurality of grating bars spaced apart one alongside another, which form a screen surface and which have a smaller dimension in the width direction, which runs parallel to the screen surface and perpendicular to the longitudinal direction of the screen grating bars, than in the height direction, wherein the height direction is perpendicular to the screen surface and perpendicular to the longitudinal direction of the grating bars and wherein the cross-section of the grating bars perpendicular to the longitudinal axis tapers with increasing distance from the screen surface in a first portion of the grating bars adjoining the screen surface, so that the width of a gap between two grating bars increases in the height direction in this height range.

### PRIOR ART

U.S. Pat. No. 4,268,384 A presents a screen having conical grating bars that is used for separating solid materials from suspensions. For this purpose, the grating bars are to be arranged perpendicular to the transport direction.

DE 10 2014 011 679 A1 presents a screen device, which can be constructed as a screen drum having profiled bars. In order to reduce the tendency to clog, it is provided that the radii of the rounded flanks at the top of the screen bar have a common center point, wherein the screen bars can be arranged perpendicular to the conveying direction or at an angle to the axis of the screen drum.

Freely vibrating screen machines on the other hand, which essentially include circular vibratory screens, linear motion screens and elliptically vibrating screens, are usually supported via spring elements—directly or indirectly—on a base. A screen box having one or more screen gratings is set into vibration by means of a drive unit.

### PROBLEM OF THE INVENTION

A problem addressed by the present invention is that of providing a screen grating of the type described above that has a lesser tendency to clog.

### PRESENTATION OF THE INVENTION

In a screen grating as mentioned above, the problem addressed by the invention is solved in that the cross section of the grating bars perpendicular to the longitudinal axis tapers down with increasing distance from the screen surface in a first portion adjoining the screen surface so that, in this height region, the width of a gap between two grating bars increases in the height direction, wherein the grating bars are parallel to one another, more particularly in the conveyance direction of the bulk material.

This can be implemented by shaping the first portion conically, i.e. by planes angled relative to one another.

In a simple embodiment, the first portion is formed from two flat plates that are arranged at an acute angle relative to one another, wherein the cavity formed by the two plates is closed off by a flat plate that runs parallel to the screen surface.

A second portion of the grating bars can be formed straight so that the width of a gap between two grating bars in this height area remains the same in the height direction. The tendency to clogging is already reduced due to the conical formation of the first portion. The second portion can, in particular, be formed in one piece with one of the two plates from the first portion that are arranged at an acute angle relative to one another. The first portion can be equally high as the second portion.

A plurality of cross-plates running in the width direction can be provided, which divide the gaps between two grating bars into a plurality of chambers.

As a rule, the grating bars are arranged parallel to one another, more particularly in the conveyance direction of the bulk material.

The grating according to the invention is preferably used in freely vibrating screen machines, which are usually mounted—directly or indirectly—on a base via spring elements, wherein a screen box containing one or more screen gratings is set into motion by means of a drive unit. Accordingly, the screen grating according to the invention can be part of a freely vibrating screen machine. In other words, the present invention can be implemented by equipping a freely vibrating screen machine with one or more screen gratings according to the invention.

### BRIEF DESCRIPTION OF THE FIGURES

The invention will now be explained in detail with reference to an embodiment. The drawings are for the sake of example and are intended to present the inventive concept but not to limit it or definitively reproduce it. Therein:

FIG. 1 shows a schematic side view of a screen grating according to the invention,

FIG. 2 shows a plan view of the screen grating from FIG. 1,

FIG. 3 shows a vertical cross-section through a screen grating from FIG. 1,

FIG. 4 shows an axonometric view of the screen grating from FIG. 1 and

FIG. 5 shows an axonometric view of a screen machine having a plurality of screen gratings according to FIG. 1.

### MODES OF EMBODYING THE INVENTION

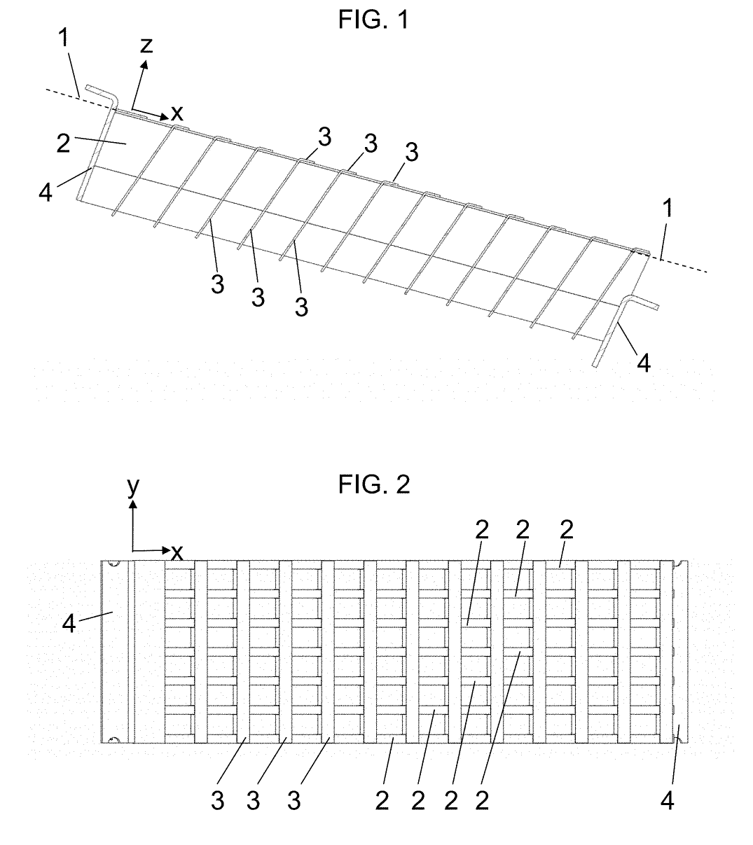

FIG. 1 shows a schematic view of a screen grating according to the invention. In the operating state, the screen grating is arranged at an angle, and the bulk material is fed at the upper left onto the screen surface 1 and moves down and to the lower right thereon in the longitudinal direction x. In this representation, only one grating bar 2 is visible, which runs parallel to the screen surface 1 or the upper side of which forms the screen surface 1. The gaps between the grating bars 2 are closed off by a plurality of cross-plates 3 running in the width direction y (perpendicular to the drawing plane), such that the screen grating is subdivided in the longitudinal direction x into a plurality of chambers. The cross-plates 3 are inclined against the conveying direction of the bulk material. The cross-plates 3 are bent over at the upper side thereof and rest in the form of a continuous strip on the upper side of the grating bars 2. The grating bars 2 are connected to one another at the longitudinal ends thereof by a common support section 4 and are fixed in their mutual positions.

FIG. 2, which shows a top view of the screen grating from FIG. 1, reveals that the height of the grating bars, i.e. the dimension thereof in the height direction z in FIG. 1, is multiple times larger than the width thereof in the width direction y in the screen surface 1. The height of the grating bars 2 in the present case is approximately 10 to 15 times the width of the grating bars 2. The screen grating in this example comprises seven grating bars 2; four to twelve grating bars 2 are typical, depending upon the application.

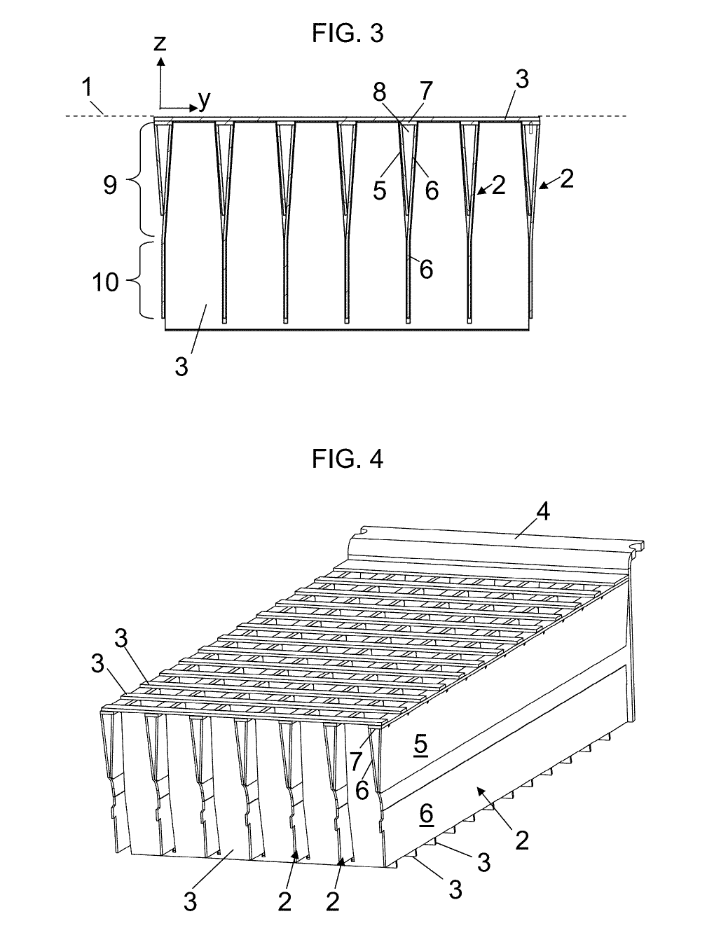

FIG. 3 shows a vertical section through the screen grating from FIG. 1 or FIG. 2 and thus a section across the longitudinal axis x of the screen bars 2, so that the width direction y and the height direction z are in the drawing plane. Each of the screen bars is formed from three plates 5-7, wherein the first and second plates 5, 6 are arranged at an acute angle to one another and the cavity 8 formed by the two plates 5, 6 is closed off by a third flat plate 7, which runs parallel to the screen surface 1. The first plate 5 is flat and somewhat less than half as high as the second plate 6. The second plate 6 is angled at half its height, the flat upper part of the plate 6 forming, together with plate 5, the cavity 8 with an acute angle. The upper part of the plate 6, together with the plate 5, thus forms the first portion 9 of the grating bars 2, which begins in the height direction z at the screen surface 1. The upper part of the plate 6 and plate 5 each enclose the same angle relative to the height direction in this case. The lower part of plate 6, which is again flat, runs parallel to the height direction z and forms the second portion 10 of the grating bar 2. In the height region of the first portion 9, the width of a gap between two grating bars 2 expands viewed from top to bottom, whereas the width of the expanded gap between 2 grating bars remains constant in the second portion 10.

FIG. 4 shows the screen grating according to the invention in an axonometric view, wherein the cross-plates 3 are once again clearly recognizable. The plates 5-7 and the cross-plates 3 generally consist of metal and are welded to one another.

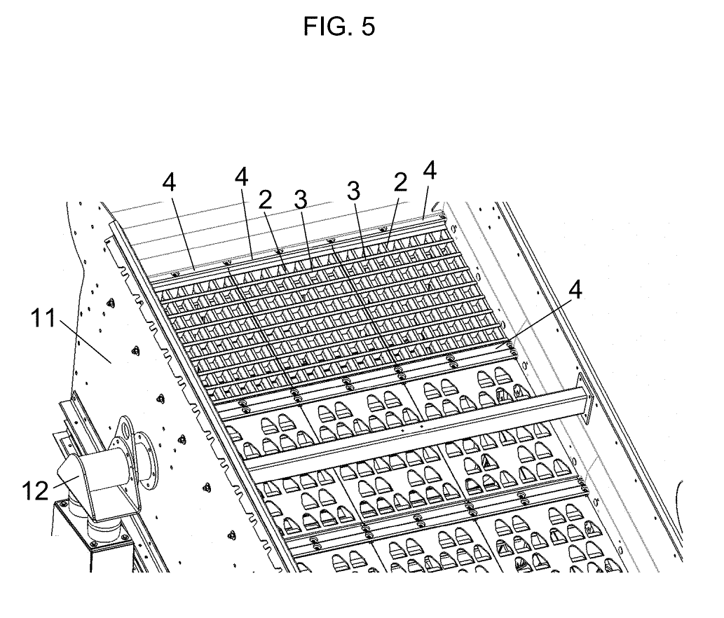

FIG. 5 shows a screen having a screen box 11 that is driven by a drive unit 12. Three identical screen gratings according to the invention, of which the cross-plates 3 and contact portions 4 are aligned with one another, are located in the region of the screen box 11.

### LIST OF REFERENCE SYMBOLS

1 Screen surface

2 Grating bar

3 Cross-plate

4 Contact portions

5 First plate

6 Second plate

7 Third plate

8 Cavity

9 First portion of grating bar 2

10 Second portion of grating bar 2

11 Screen box

12 Drive unit

x Length direction

y Width direction

z Height direction

1. A screen grating for size-dependent separation of bulk materials, comprising a plurality of grating bars spaced apart one alongside another, which form a screen surface and which have a smaller dimension in the width direction (y), which runs parallel to the screen surface and perpendicular to the longitudinal direction (x) of the screen grating bars, than in the height direction (z), wherein the height direction (z) is perpendicular to the screen surface and perpendicular to the longitudinal direction (x) of the grating bars and wherein the cross-section of the grating bars perpendicular to the longitudinal axis (x) tapers with increasing distance from the screen surface in a first portion of the grating bars adjoining the screen surface, so that the width of a gap between two grating bars increases in the height direction in this height range, wherein the grating bars are arranged parallel to one another, in the conveyance direction of the bulk material.

2. The screen grating according to claim 1, characterized in that the first portion has a conical shape.

3. The screen grating according to claim 1, characterized in that the first portion is formed from two flat plates that are arranged at an acute angle relative to one another, wherein the cavity formed by the two plates is closed off by a flat plate that runs parallel to the screen surface.

4. The screen grating according to claim 1, characterized in that a second portion of the grating bars is formed straight, such that the width of a gap between two grating bars in this height range remains constant.

5. The screen grating according to claim 4, characterized in that the second portion is formed as a flat plate.

6. The screen grating according to claim 3, characterized in that the second portion is formed integrally with one of the two plates from the first portion, which are arranged at an acute angle to one another.

7. The screen grating according to claim 4, characterized in that the first portion is equally high as the second portion.

8. The screen grating according to claim 1, characterized in that a plurality of cross-plates extending in the width direction (y) are provided, which subdivide the gaps between two grating bars into a plurality of chambers.

9. A freely vibrating screen machine having at least one screen grating according to claim 1.
